(19) United States
(12) Patent Application Publication
(10) Pub. No.: US 2024/0255863 A1
(43) Pub. Date: Aug. 1, 2024

(54) STATIC ELIMINATION APPARATUS AND IMAGE FORMING APPARATUS

(71) Applicant: CANON KABUSHIKI KAISHA, Tokyo (JP)

(72) Inventors: KOJI SUZUKI, Chiba (JP); SHINGO IWAMI, Tokyo (JP); RYO AIHARA, Chiba (JP); KAZUYA NUMATA, Ibaraki (JP)

(21) Appl. No.: 18/424,608

(22) Filed: Jan. 26, 2024

(30) Foreign Application Priority Data
Jan. 30, 2023 (JP) 2023-011452

(51) Int. Cl. G03G 15/02; G03G 15/20

(52) U.S. Cl. CPC G03G 15/0266; G03G 15/2014

(57) ABSTRACT

A static elimination apparatus includes a conveyance unit to convey a sheet along a conveyance path, a non-contact type static elimination unit to perform static elimination on the sheet without being in contact with the sheet, and first and second guide members. The first guide member includes a contact portion to guide the sheet and a plurality of openings arranged in a sheet widthwise direction perpendicular to a sheet conveyance direction to expose the non-contact type static elimination unit to the conveyance path. The second guide member is disposed to face the first guide member and forms a part of the conveyance path together with the first guide member. The contact portion includes an inclined portion upstream in the sheet conveyance direction. The inclined portion is inclined so that a distance to the second guide member decreases downstream in the sheet conveyance direction.

### BACKGROUND

### Field

The present disclosure relates to a static elimination apparatus for performing static elimination on a sheet and an image forming apparatus having the static elimination apparatus.

### Description of the Related Art

In image forming apparatuses, such as copiers and facsimile apparatuses, a sheet charged during image forming and ejected sticks to another ejected sheet by the electrostatic force between the ejected sheets.

There are proposed image forming apparatuses each provided with a static elimination apparatus for performing static elimination on sheets. For example, Japanese Patent Application Laid-Open No. 2021-111527 discusses a static elimination apparatus including a contact type static elimination unit (static elimination rollers) for performing static elimination on sheets being conveyed while in contact with the sheets, and a non-contact type static elimination unit (discharge wire) for performing static elimination on sheets without being in contact with the sheets.

The static elimination apparatus discussed in Japanese Patent Application Laid-Open No. 2021-111527, a portion where the non-contact type static elimination unit is disposed in a sheet conveyance path is formed with a guide member (shielding member) having a plurality of openings. The non-contact type static elimination unit is exposed to the conveyance path through the plurality of openings arranged in the guide member, making it possible to perform static elimination on the conveyed sheets.

However, the conventional method may cause a conveyance failure when a sheet is subjected to static elimination by the non-contact type static elimination unit.

### SUMMARY

The present disclosure is directed to providing a static elimination apparatus capable of reducing conveyance failures when sheets pass by a non-contact type static elimination unit, and an image forming apparatus having the static elimination apparatus.

According to an aspect of the present disclosure, a static elimination apparatus includes a conveyance unit configured to convey a sheet along a conveyance path, a non-contact type static elimination unit configured to perform static elimination on the sheet being conveyed by the conveyance unit without being in contact with the sheet, a first guide member including a contact portion configured to guide the sheet with the contact portion being in contact with the sheet being conveyed by the conveyance unit, having a plurality of openings arranged in a sheet widthwise direction perpendicular to a sheet conveyance direction and configured to expose the non-contact type static elimination unit to the conveyance path, and configured to form a part of the conveyance path, and a second guide member disposed to face the first guide member and configured to form a part of the conveyance path together with the first guide member, wherein the contact portion includes an inclined portion upstream in the sheet conveyance direction, wherein the inclined portion is inclined so that a distance to the second guide member decreases downstream in the sheet conveyance direction

Further features of the present disclosure will become apparent from the following description of exemplary embodiments with reference to the attached drawings.

### BRIEF DESCRIPTION OF THE DRAWINGS

FIG. 1 is a general view illustrating an image forming apparatus.

FIG. 2 is a cross-sectional view schematically illustrating a printing apparatus.

FIG. 3 is a cross-sectional view schematically illustrating a static elimination apparatus.

FIG. 4 is a perspective view illustrating a guide unit.

FIG. 5 is a top view illustrating an upper guide member.

FIG. 6 is an enlarged view illustrating a part of the upper guide member closer to the rear end of the image forming apparatus.

FIG. 7 is a perspective view illustrating the upper guide member viewed from a conveyance path side.

FIG. 8 is an enlarged view illustrating a rib of the upper guide member.

FIG. 9 is a side view illustrating an inclined portion of the rib.

### DESCRIPTION OF THE EMBODIMENTS

Exemplary embodiments of the present disclosure will be described with reference to the accompanying drawings. Sizes, materials, shapes, or relative arrangements of components described in the exemplary embodiments do not limit the scope where the present disclosure is applied unless otherwise specifically described.

### Image Forming Apparatus

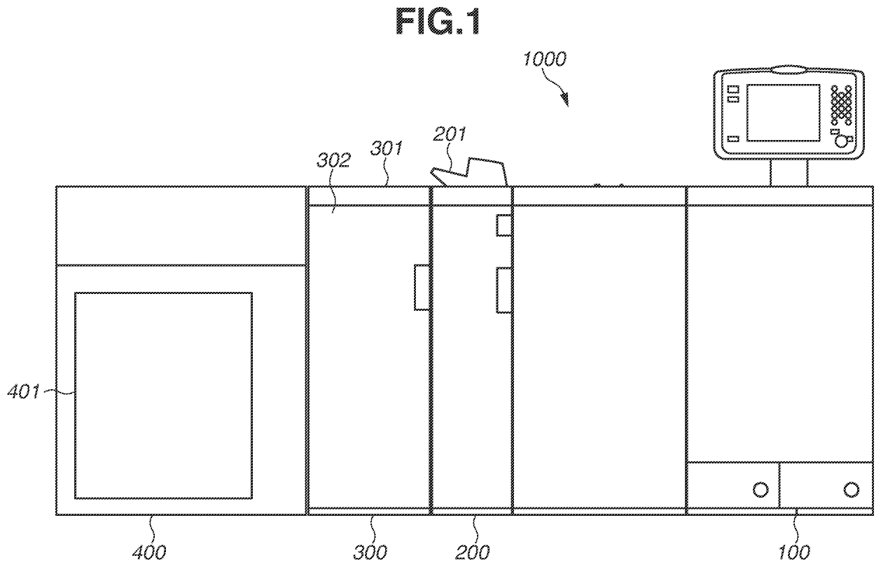

FIG. 1 illustrates an overall hardware configuration of an image forming apparatus 1000 according to the present exemplary embodiment. The image forming apparatus 1000 includes a printing apparatus 100, an inserter 200, a static elimination apparatus 300, and a large-capacity stacker 400. The printing apparatus 100 forms an image on a sheet based on an instruction from an external apparatus (not illustrated). The inserter 200 conveys the sheet conveyed from the printing apparatus 100 to the static elimination apparatus 300. The inserter 200 also feeds a sheet inserted from a feed tray 201 and inserts the sheet between two sheets conveyed from the printing apparatus 100. The static elimination apparatus 300 performs static elimination on sheets conveyed from printing apparatus 100 via the inserter 200. The large-capacity stacker 400 stacks sheets conveyed from the static elimination apparatus 300. The sheets conveyed from the printing apparatus 100 through the inserter 200 and the static elimination apparatus 300 are ejected to an ejection tray 401 of the large-capacity stacker 400.

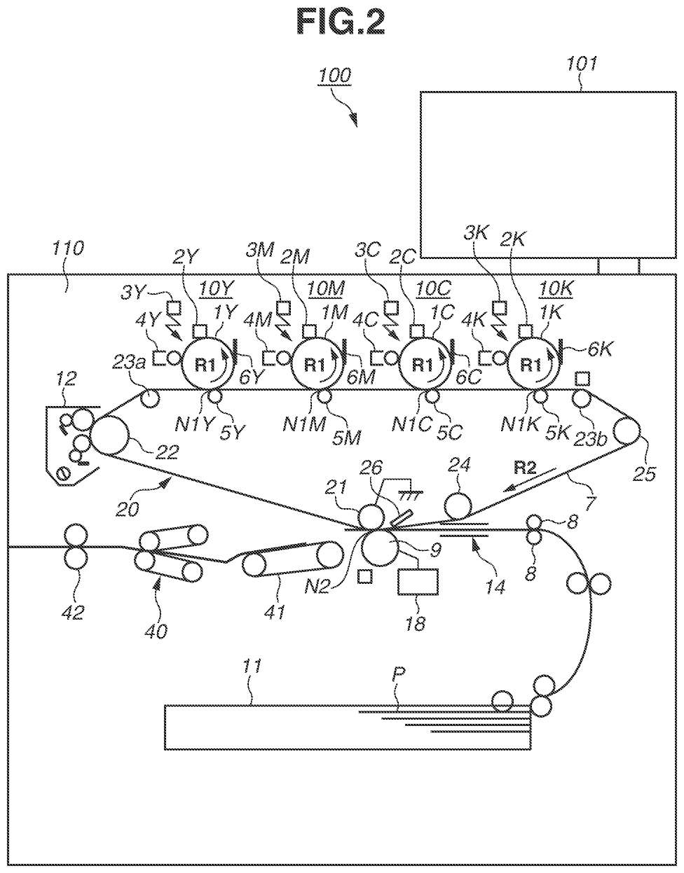

While the image forming apparatus 1000 according to the present exemplary embodiment includes the printing apparatus 100, the inserter 200, the static elimination apparatus 300, and the large-capacity stacker 400, the configuration of the image forming apparatus 1000 is not limited thereto. For example, the image forming apparatus 1000 may include another finisher downstream of the large-capacity stacker 400. The static elimination apparatus 300 may be directly connected to the printing apparatus 100 without the inserter 200 or the large-capacity stacker 400. In the image forming apparatus 1000, the static elimination apparatus 300 may be integrally included in a housing 110 (FIG. 2) of the printing apparatus 100.

### Printing Apparatus

FIG. 2 is a cross-sectional view schematically illustrating the printing apparatus 100. The printing apparatus 100 according to the present exemplary embodiment is a tandem multifunction peripheral (having functions of a copying machine, a printer, and a facsimile apparatus) with an intermediate transfer method. For example, the printing apparatus 100 can form a full-color image on a sheet P, such as paper (e.g., transfer material, sheet material, recording medium, and other media), by an electrophotographic method based on image signals transmitted from an external apparatus.

The printing apparatus 100 includes a plurality of image forming units (stations), i.e., four different image forming units 10Y, 10M, 10C, and 10K for forming a yellow (Y), a magenta (M), a cyan (C), and a black (K) image, respectively. The image forming units 10Y, 10M, 10C, and 10K are disposed in a row in the direction of movement of the image transfer surface of an intermediate transfer belt 7 (described below) disposed in a substantially horizontal manner. Elements having an identical or corresponding to function or configuration in the image forming units 10Y, 10M, 10C, and 10K are comprehensively described below in some cases with end letters “Y”, “M”, “C”, and “K” of reference numerals representing respective colors omitted. An image forming unit 10 includes a photosensitive drum 1 (1Y, 1M, 1C, and 1K), a charging device 2 (2Y, 2M, 2C, and 2K), an exposure device 3 (3Y, 3M, 3C, and 3K), a developing device 4 (4Y, 4M, 4C, and 4K), a primary transfer roller 5 (5Y, 5M, 5C, and 5K), and a cleaning device 6 (6Y, 6M, 6C, and 6K).

The photosensitive drum 1, a rotatable drum type (cylindrical) photosensitive member, is a first image carrier for carrying toner images. The photosensitive drum 1 is rotatably driven in the direction of an arrow R1 in FIG. 2 (counterclockwise direction) by a driving force transmitted from a drum drive motor (not illustrated). A surface of the rotating photosensitive drum 1 is uniformly charged to a predetermined potential having a predetermined polarity (negative polarity according to the present exemplary embodiment) by the charging device 2 (charging unit). In the charge process, a predetermined charge voltage is applied to the charging device 2 by a charging power source (not illustrated). The surface of the charged photosensitive drum 1 is subjected to scanning exposure by the exposure device 3 (exposure unit) according to image signals, forming an electrostatic latent image on the photosensitive drum 1. According to the present exemplary embodiment, the exposure device 3 includes a laser scanner device for emitting laser beams modulated with image information to the photosensitive drum 1. The electrostatic image formed on the photosensitive drum 1 is developed with toner (developer) supplied by the developing device 4 (developing unit), forming a toner image on the photosensitive drum 1. According to the present exemplary embodiment, toner charged to the same polarity as the charging polarity of the photosensitive member 1 adheres to the exposed portions at potentials whose values are absolutely lower than the value of the potential of the surface on the photosensitive member 1 uniformly charged. The developing device 4 includes a developing roller as a rotatable developer carrier for carrying and conveying the developer to the developing position facing the photosensitive drum 1. The developing roller is rotatably driven by a driving force transmitted from, for example, the drive system of the photosensitive drum 1. In the development process, a predetermined developing voltage is applied to the developing roller by a developing power source (not illustrated).

The intermediate transfer belt 7, a rotatable intermediate transfer member including an endless belt, is disposed facing the four photosensitive drums 1Y, 1M, 1C, and 1K, as a second image carrier for carrying toner images. The intermediate transfer belt 7 is suspended with a plurality of rollers with a predetermined tension. The plurality of rollers includes a drive roller 22, an upstream auxiliary roller 23a, a downstream auxiliary roller 23b, a tension roller 25, a secondary pre-transfer roller 24, and an inner roller 21. The drive roller 22 transfers a driving force to the intermediate transfer belt 7. The tension roller 25 applies a predetermined tension to the intermediate transfer belt 7 to control the tension of the intermediate transfer belt 7 to be constant. The secondary pre-transfer roller 24 forms the surface of the intermediate transfer belt 7 in the vicinity upstream of a secondary transfer nip N2 in the rotational direction of the intermediate transfer belt 7. The inner roller 21 functions as a counter member of an outer roller 9. The upstream auxiliary roller 23a and the downstream auxiliary roller 23b form a substantially horizontal image transfer surface. The drive roller 22 is rotatably driven by a driving force transferred from a belt drive motor (not illustrated). Thus, the intermediate transfer belt 7 is driven by the drive roller 22 to rotate in the direction of an arrow R2 in FIG. 2 (clockwise rotation). According to the present exemplary embodiment, the intermediate transfer belt 7 is rotatably driven with a circumferential speed of 150 to 470 mm/sec. The plurality of tension rollers other than the drive roller 22 is driven to rotate with the rotation of the intermediate transfer belt 7. The inner circumferential surface of the intermediate transfer belt 7 is provided with the primary transfer rollers 5Y, 5M, 5C, and 5K (roller-shaped primary transfer members as primary transfer units) corresponding to the photosensitive drums 1Y, 1M, 1C, and 1K, respectively. The primary transfer roller 5 presses the intermediate transfer belt 7 toward the photosensitive drum 1 to form a primary transfer nip N1 (primary transfer portion) as a contact point between the photosensitive drum 1 and the intermediate transfer belt 7. The inner circumferential surface of the intermediate transfer belt 7 is provided with a pressing member 26 upstream of the inner roller 21 and downstream of the secondary pre-transfer roller 24 in the rotational direction of the intermediate transfer belt 7. The pressing member 26 that is in contact with the inner circumferential surface of the intermediate transfer belt 7 presses the intermediate transfer belt 7 in the direction from the inner circumferential surface to the outer circumferential surface of the intermediate transfer belt 7.

The toner image formed on the photosensitive drum 1 in this way is primarily transferred onto the rotating intermediate transfer belt 7 at the primary transfer nip N1 by the action of the primary transfer roller 5. In the primary transfer process, a primary transfer voltage (direct-current (DC) voltage) is applied to the primary transfer roller 5 by a primary transfer power source (not illustrated). This voltage has the polarity (positive polarity according to the present exemplary embodiment) opposite to the normal charging polarity of the toner. In the full-color image forming process, for example, yellow, magenta, cyan, and black toner images formed on the respective photosensitive drums 1 are sequentially transferred onto the intermediate transfer belt 7 so that these images are superimposed in an image forming region. According to the present exemplary embodiment, the primary transfer nip N1 is the image forming position where a toner image is formed on the intermediate transfer belt 7. The intermediate transfer belt 7 is an example of a rotatable endless belt for conveying the toner image carried at the image forming position.

On the outer circumferential surface of the intermediate transfer belt 7, the outer roller 9 is disposed as a roller-shaped secondary transfer member (secondary transfer unit) at a position facing the inner roller 21. The outer roller 9 is pressed toward the inner roller 21 via the intermediate transfer belt 7 to form a secondary transfer nip N2 (secondary transfer portion) as a contact point between the intermediate transfer belt 7 and the outer roller 9. At the secondary transfer nip N2, the toner image formed on the intermediate transfer belt 7 in this way is secondarily transferred onto the sheet P by the action of the outer roller 9 while the sheet P is being conveyed sandwiched by the intermediate transfer belt 7 and the outer roller 9. In the secondary transfer process, a secondary transfer voltage (DC voltage) is applied to the outer roller 9 by a secondary transfer power source 18. This voltage is a constant-voltage controlled direct voltage with the polarity (positive polarity according to the present exemplary embodiment) opposite to the normal charging polarity of the toner. According to the present exemplary embodiment, for example, with a secondary transfer voltage of +1 to +7 kV and a secondary transfer current of +40 to +120 μA applied to the outer roller 9, the toner image on the intermediate transfer belt 7 is secondarily transferred onto the sheet P. According to the present exemplary embodiment, the inner roller 21 is electrically grounded (connected to the ground). The inner roller 21 may also be used as a secondary transfer member where a secondary transfer voltage having the same polarity as the normal charging polarity of the toner is applied to the inner roller 21 with the outer roller 9 facing the inner roller 21 electrically grounded.

The sheet P is conveyed to the secondary transfer nip N2 in synchronization with the toner image on the intermediate transfer belt 7. More specifically, the sheet P stored in a recording material cassette 11 as a recording material storage unit is conveyed to a registration roller 8 by a feed roller and then temporarily stopped. Then, the registration roller 8 is rotatably driven to feed the sheet P to the secondary transfer nip N2 so that the toner image on the intermediate transfer belt 7 coincides with the desired image forming region on the sheet P. A conveyance guide 14 for guiding the sheet P to the secondary transfer nip N2 is disposed downstream of the registration roller 8 and upstream of the secondary transfer nip N2 in the sheet P conveyance direction (hereinafter simply refers to as conveyance direction).

The sheet P with the toner image transferred thereon is conveyed to a fixing device 40 (fixing unit) by a pre-fixing conveyance unit 41. The pre-fixing conveyance unit 41 is provided with a rotatable belt member made of a rubber material, such as ethylene propylene diene monomer (EPDM), with a width of 100 to 110 mm and a thickness of 1 to 3 mm at the center of the pre-fixing conveyance unit 41 in the sheet widthwise direction (hereinafter simply referred to as the widthwise direction) perpendicular to the sheet P conveyance direction. The pre-fixing conveyance unit 41 conveys the sheet P placed on the belt member. The belt member has holes with a diameter of 3 to 7 mm through which air is sucked from the inner circumferential surface of the belt member to intensify the force of holding the sheet P, stabilizing the conveyance performance of the sheet P. In the process of conveying the sheet P carrying the non-fixed image being sandwiched through a fixing rotary member pair, the fixing device 40 heats and pressurizes the sheet P (melting and fixing process) to fix the toner image onto the surface of the sheet P. Then, the sheet P with the toner image fixed thereon is conveyed to the inserter 200 by an exit roller pair 42.

Meanwhile, the toner remaining on the photosensitive drum 1 after the primary transfer process is removed from the photosensitive drum 1 and collected by a cleaning device 6 (cleaning unit). Residual toner on the intermediate transfer belt 7 and paper dust and other substances falling thereon from the sheet P after the secondary transfer process are removed from the intermediate transfer belt 7 and collected by a belt cleaning device 12 (intermediate transfer member cleaning unit). According to the present exemplary embodiment, the belt cleaning device 12 electrostatically collects the substances, such as secondary transfer residual toner on the intermediate transfer belt 7, to clean the intermediate transfer belt 7.

According to the present exemplary embodiment, the intermediate transfer belt 7 stretched by the plurality of tension rollers, the transfer rollers 5, the belt cleaning device 12, and frames for supporting these parts are included in an intermediate transfer belt unit 20 (belt conveyance unit). The intermediate transfer belt unit 20 is supported attachable to and detachable from the housing 110 of the printing apparatus 100 for maintenance and parts replacement. The intermediate transfer belt 7 may be formed of a single-or multi-layer structure made of a resin material or resin materials, or a multi-layer structure including an elastic layer made of an elastic material.

According to the present exemplary embodiment, the primary transfer roller 5 includes a metallic core, and an elastic layer made of an ion conductive foam rubber layered around the core. According to the present exemplary embodiment, the primary transfer roller 5 has an outer diameter of 15 to 20 mm and an electrical resistance of 1×10⁵ to 1×10⁸Ω measured when a 2 kV voltage is applied in an environment with 23° C. and 50% RH.

According to the present exemplary embodiment, the outer roller 9 includes a metallic core, and an elastic layer made of an ion conductive foam rubber layered around the core. According to the present exemplary embodiment, the outer roller 9 has an outer diameter of 20 to 25 mm and an electrical resistance of 1×10⁵ to 1×10⁸Ω measured when a 2 kV voltage is applied in an environment with 23° C. and 50% RH. The outer roller 9 that is in contact with the inner roller 21 across the intermediate transfer belt 7 with a predetermined pressure forms the secondary transfer nip N2.

According to the present exemplary embodiment, the inner roller 21 includes a metallic core, and an elastic layer made of an electronic conductive rubber layered around the core. According to the present exemplary embodiment, the inner roller 21 has an outer diameter of 20 to 22 mm and an electrical resistance of 1×10⁵ to 1×10⁸Ω measured when a 50 V voltage is applied in an environment with 23° C. and 50% RH. The secondary pre-transfer roller 24 can be configured, for example, in a similar way to the inner roller 21. According to the present exemplary embodiment, the rotation axis directions of the tension rollers of the intermediate transfer belt 7 including the inner roller 21 and the rotation axis direction of the outer roller 9 are approximately parallel to each other.

### Static Elimination Apparatus

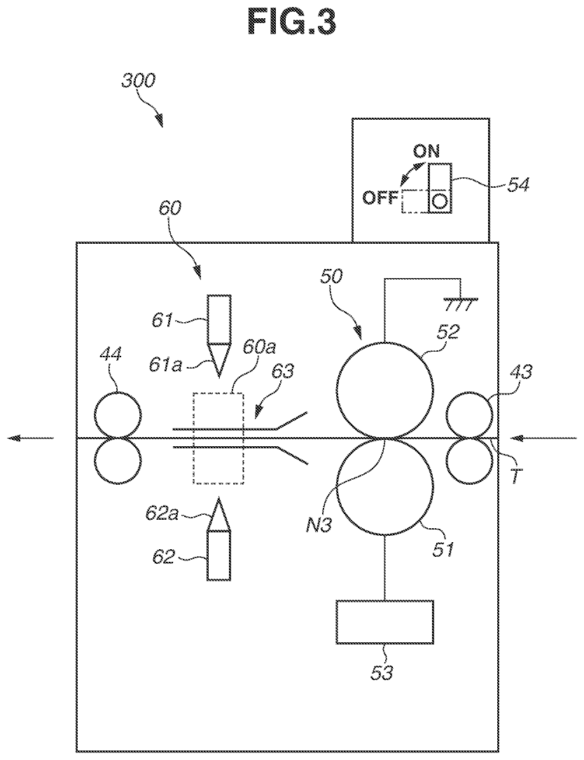

The static elimination apparatus 300 according to the present exemplary embodiment will be described with reference to FIG. 3. FIG. 3 is a cross-sectional view schematically illustrating the static elimination apparatus 300. In the image forming apparatus 1000, the static elimination apparatus 300 is disposed downstream of the printing apparatus 100 and the inserter 200. The sheet P may be charged in the above-described image forming process of the printing apparatus 100. With the sheet P charged, a plurality of sheets P ejected to the ejection tray 401 sticks to each other by electrostatic force, which can result in a stacking failure. According to the present exemplary embodiment, the static elimination apparatus 300 performs the static elimination on the sheet P with an image formed thereon by the printing apparatus 100.

The static elimination apparatus 300 includes a static elimination roller pair 50 (contact type static elimination unit) for performing static elimination on the sheet P with the static elimination roller pair 50 in contact with the sheet P, and a non-contact type static elimination section 60 for performing static elimination on the sheet P without being in contact with the sheet P. The static elimination apparatus 300 includes an entry roller pair 43 for receiving the sheet P from the inserter 200 and conveying it along a conveyance path T, and an exit roller pair 44 for ejecting the sheet P subjected to the static elimination by the static elimination roller pair 50 and the non-contact type static elimination section 60, to a large-capacity stacker 400. The entry roller pair 43 and the exit roller pair 44 are examples of the conveyance units according to the present exemplary embodiment.

The static elimination roller pair 50 includes a static elimination roller 51 that rotates contacting the lower surface of the sheet P, and a static elimination counter roller 52 that rotates contacting the upper surface of the sheet P. The static elimination roller 51 includes a metallic core, and an elastic layer made of an ion conductive foam rubber layered around the core. According to the present exemplary embodiment, the static elimination roller 51 has an outer diameter of 20 to 25 mm and an electrical resistance of 1×10⁵ to 1×10⁸Ω measured when a 2 kV voltage is applied in an environment with 23° C. and 50% RH. For example, the static elimination roller 51 may be made of the same material as the outer roller 9. The static elimination counter roller 52 with an outer diameter of 20 to 25 mm forms a static elimination nip portion N3 with the static elimination roller 51.

A sheet P conveyed from the printing apparatus 100 is initially subjected to coarse static elimination at the static elimination nip portion N3 formed by the static elimination roller pair 50. A static elimination voltage (DC voltage) is applied to the static elimination roller 51 by a static elimination power source 53. This voltage is a constant-voltage controlled direct voltage with the polarity (negative polarity according to the present exemplary embodiment) opposite to the polarity of the secondary transfer member (outer roller 9). According to the present exemplary embodiment, for example, a static elimination voltage of −1 to −7 kV is applied to the static elimination roller 51. The static elimination apparatus 300 is provided with a switch 54 that enables the operator to turn the voltage application to the static elimination roller pair 50 ON or OFF. The static elimination counter roller 52 is electrically grounded (connected to the ground).

Then, the sheet P that has passed through the static elimination roller pair 50 is subjected to the static elimination by the non-contact type static elimination section 60 disposed downstream of the static elimination roller pair 50. The non-contact type static elimination section 60 eliminates electric charge on the sheet P of which the charge has not been eliminated through the static elimination by the static elimination roller pair 50. The non-contact type static elimination section 60 includes a non-contact type static elimination unit 61 (first non-contact type static elimination unit or upper static elimination unit) disposed above the conveyance path T, and a non-contact type static elimination unit 62 (second non-contact type static elimination unit or lower static elimination unit) disposed below the conveyance path T. In other words, according to the present exemplary embodiment, the non-contact type static elimination units 61 and 62 are disposed above and below the conveyance path T, respectively, in the non-contact type static elimination section 60. According to the present exemplary embodiment, the non-contact type static elimination units 61 and 62 includes static elimination needles 61a and 62a, respectively, for producing ions for performing static elimination on the sheet P. The non-contact type static elimination units 61 and 62 are ionizers for emitting ions to the sheet P being conveyed in a static elimination region 60a. The static elimination needle 61a is an example of a first ion emission unit, and the static elimination needle 62a is an example of a second ion emission unit. However, the non-contact type static elimination units 61 and 62 may be, for example, non-contact type static elimination units including a discharge wire.

The non-contact type static elimination section 60 is provided with a guide unit 63 for forming a part of the conveyance path T (static elimination region 60a). The guide unit 63 is disposed below the non-contact type static elimination unit 61 and above the non-contact type static elimination unit 62 in the vertical direction. In other words, the guide unit 63 is disposed between the non-contact type static elimination units 61 and 62. In the non-contact type static elimination section 60, the sheet P is subjected to the static elimination by the non-contact type static elimination units 61 and 62 passing through the guide unit 63. According to the present exemplary embodiment, the sheet P is transferred from the static elimination roller pair 50 to the guide unit 63.

### Guide Unit

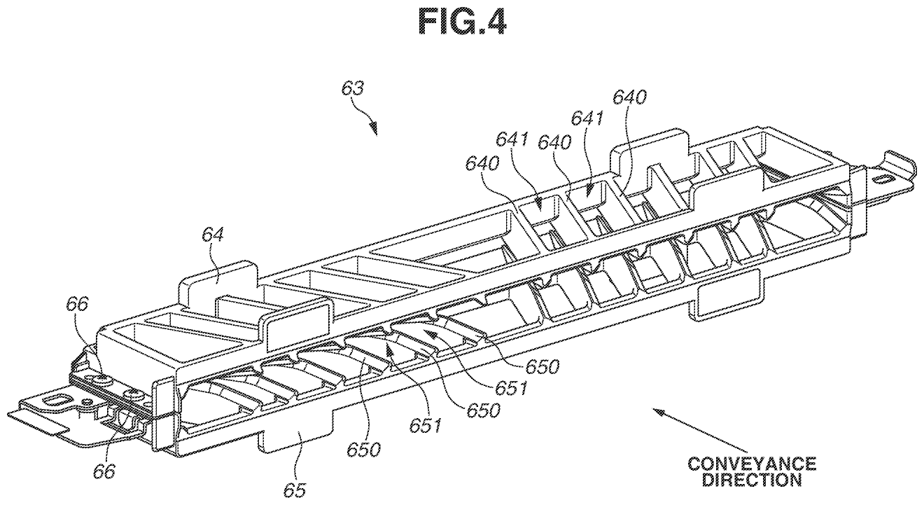

FIG. 4 is a perspective view illustrating the guide unit 63. The guide unit 63 includes an upper guide member 64 (first guide member) for guiding the sheet P facing the upper surface of the sheet P, and a lower guide member 65 (second guide member) for guiding the sheet P facing the lower surface of the sheet P.

The lower guide member 65 forms the static elimination region 60a in the conveyance path T with the upper guide member 64. The sheet P that has passed through the static elimination roller pair 50 is conveyed between the upper guide member 64 and the lower guide member 65. According to the present exemplary embodiment, the upper guide member 64 and the lower guide member 65 are made of insulating resin material having a volume resistivity of 1×10¹⁴ Ω·cm. The upper guide member 64 and the lower guide member 65 are fixed to each other with a plurality of screws 66 provided at both ends in the widthwise direction, thus forming one guide unit 63.

The upper guide member 64 is provided with a plurality of ribs 640 disposed in the widthwise direction, and a plurality of openings 641 formed between the plurality of ribs 640. The plurality of ribs 640 arranged on the upper guide member 64 serves as an upper surface contact portion for guiding the sheet P contacting the upper surface thereof. The plurality of ribs 640 extends in a direction inclined with respect to the conveyance direction. For example, the angle of each rib 640 formed with respect to the conveyance direction is 20 to 50 degrees. The plurality of openings 641 exposes the static elimination needle 61a of the non-contact type static elimination unit 61 to the conveyance path T. Like the upper guide member 64, the lower guide member 65 is provided with a plurality of ribs 650 arranged in the widthwise direction, and a plurality of openings 651 formed between the plurality of ribs 650. The plurality of ribs 650 arranged on the lower guide member 65 serves as a lower surface contact portion for guiding the lower surface of the sheet P contacting the lower surface thereof. Referring to FIG. 4, to avoid being a complicated drawing, some of the ribs 640 and 650 and some of the openings 641 and 651 are assigned reference numerals. According to the present exemplary embodiment, the upper guide member 64 and the lower guide member 65 have the same shape.

The ribs 640 of the upper guide member 64 guide the sheet P contacting the upper surface thereof, and the ribs 650 of the lower guide member 65 guide the sheet P contacting the lower surface thereof. Ions emitted from the non-contact type static elimination unit 61 pass through the openings 641 of the upper guide member 64 and are projected to the upper surface of the sheet P. Ions emitted from the non-contact type static elimination unit 62 pass through the openings 651 of the lower guide member 65 and are projected to the lower surface of the sheet P. The openings 641 and 651 formed in the guide unit 63 prevent ions emitted from the non-contact type static elimination units 61 and 62 from being physically blocked, enabling the non-contact type static elimination section 60 to perform the static elimination on the sheet P.

### Shapes of Guide Members

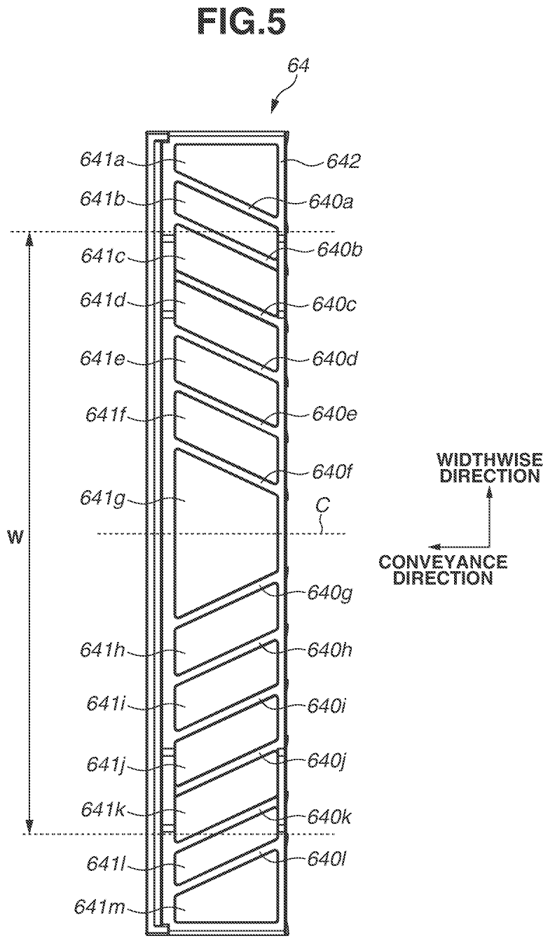

The shape of the upper guide member 64 will be described. According to the present exemplary embodiment, the lower guide member 65 has the same shape as the upper guide member 64, and a redundant description thereof will be omitted. FIG. 5 is a top view illustrating the upper guide member 64. Referring to FIG. 5, a conveyance center C is the center position of the sheet conveyance region in the widthwise direction. The upper guide member 64 includes the plurality of ribs 640 (640a to 640l), the plurality of openings 641 (641a to 641m), and a frame 642 forming the outer circumference of the upper guide member 64. The ribs 640a to 640f of the plurality of ribs 640 are disposed closer to the rear end of the image forming apparatus than the conveyance center C. The ribs 640g to 640l of the ribs 640 are disposed closer to the front end of the image forming apparatus than the conveyance center C.

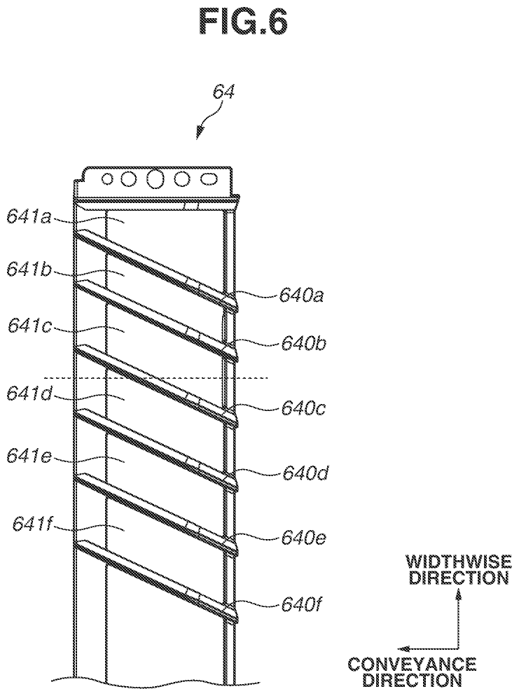

FIG. 6 is an enlarged view illustrating a part of upper guide member 64 closer to the rear end. In the upper guide member 64, the distance between two adjacent ribs 640 at positions closer to the conveyance center C is larger than the distance between two adjacent ribs 640 at positions farther away from the conveyance center C. More specifically, the width of the opening 641f (first opening) between the rib 640e (first rib) and the rib 640f (second rib) close to the conveyance center C is larger than the width of the opening 641b (second opening) between the rib 640a (third rib) and the rib 640b (fourth rib) away from the conveyance center C. According to the present exemplary embodiment, the openings 641d, 641e, and 641f have the same size. According to the present exemplary embodiment, the rib 640a to 640f disposed closer to the rear end of the image forming apparatus and the ribs 640g to 640l disposed closer to the front end of the image forming apparatus are symmetrically disposed with respect to the conveyance center C. More specifically, the upper guide member 64 is bilaterally-symmetric in the widthwise direction. Thus, the width of the opening 641h between the ribs 640g and 640h closer to the conveyance center C is larger than the width of the opening 641l between the ribs 640k and 640l farther away from the conveyance center C. Symmetrically disposing the plurality of ribs 640 with respect to the conveyance center C in the widthwise direction makes the conveyance resistance applied to the conveyed sheet P approximately bilaterally identical, preventing the skew of the sheet P.

A region W in FIG. 5 has a width of 250 mm and the conveyance center C as its center position. In the region W of the upper guide member 64, the plurality of ribs 640 is disposed so that only one rib comes into contact with a widthwise end of the sheet P. More specifically, in the region W, the plurality of ribs 640 (640c to 640j) is disposed not to overlap with each other when viewed in the conveyance direction. On the other hand, in the region outside the region W, two of the plurality of ribs 640 are disposed to be in contact with the corresponding edge of the sheet P. More specifically, in the region outside the region W, the plurality of ribs 640 (the ribs 640a and 640b, and the ribs 640k and 640l) is disposed to overlap with each other when viewed in the conveyance direction. This disposition of the plurality of ribs 640 increases the width of the openings 641 in the region W as the widthwise center region, making it possible to improve the static elimination efficiency of the non-contact type static elimination section 60.

In the region outside the region W in the widthwise direction, two ribs 640 come into contact with the corresponding edge of the sheet P, making it possible to improve the conveyance performance of a sheet having a large width.

When the upper guide member 64 is viewed from above, the percentage of the total area of the plurality of openings 641 with respect to the area of the entire upper guide member 64 (frame unit 642), opening ratio, is 60% or more. The upper guide member 64 is shaped in such a way that the percentage of the total area of the openings 641 is 60% or more at any widthwise position. Since the opening percentage of the upper guide member 64 is 60% or more, ions emitted from the non-contact type static elimination unit 61 are efficiently projected onto the sheet P.

As illustrated in FIG. 5, the plurality of ribs 640 of the upper guide member 64 is obliquely extended in the conveyance direction so that the distance from the conveyance center C increases downstream in the conveyance direction. In other words, the plurality of ribs 640 is inclined in the conveyance direction so that each rib 640 outwardly extends in the widthwise direction downstream in the conveyance direction. More specifically, the ribs 640a to 640f disposed closer to the rear end of the image forming apparatus are inclined toward the rear end of the image forming apparatus while the ribs 640g to 640l disposed closer to the front end of the image forming apparatus are inclined toward the front end of the image forming apparatus. For example, the rib 640a disposed on one side of the conveyance center C and the rib 640l disposed on the other side of the conveyance center C are inclined so that the two ribs 640 are farther away from each other downstream in the conveyance direction.

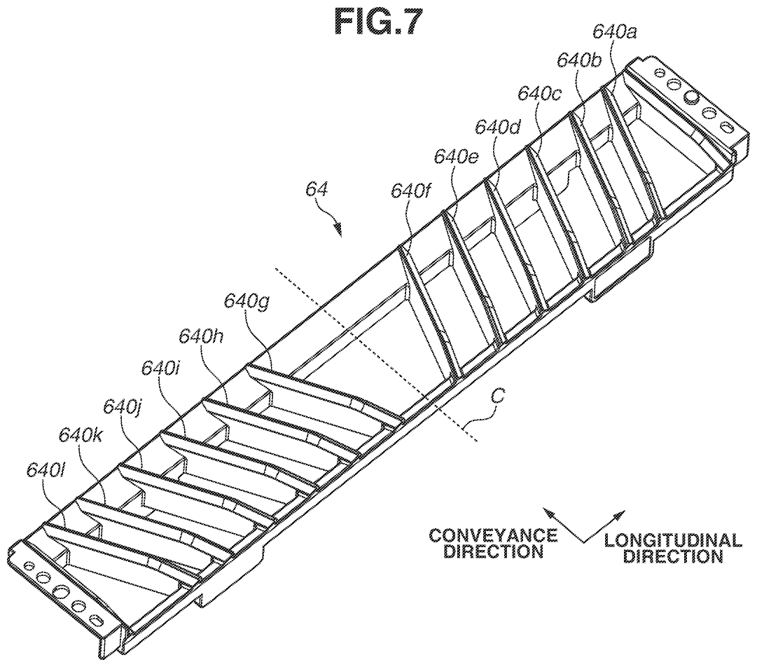

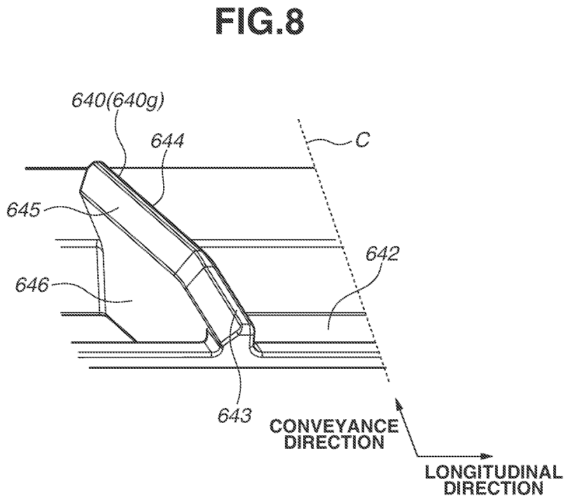

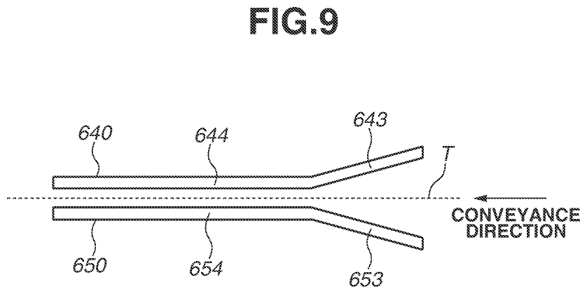

The shape of the ribs 640 will now be described in detail. FIG. 7 is a perspective view illustrating the upper guide member 64 as viewed from the conveyance path T. FIG. 8 is an enlarged view illustrating a rib 640 (640g). FIG. 9 is a side view illustrating the ribs 640 of the upper guide member 64 and the ribs 650 of the lower guide member 65 as viewed from the widthwise direction. According to the present exemplary embodiment, the ribs 640h to 640l have the same shape as the rib 640g, and the ribs 640a to 640f have a shape symmetric to that of the rib 640g with respect to the conveyance center C.

The ribs 640 of the upper guide member 64 each include an inclined portion 643 (first inclined portion) inclined so that the distance to the lower guide member 65 decreases downstream in the conveyance direction, and a downstream contact portion 644 extending from the inclined portion 643 downstream in the conveyance direction. The inclined portion 643 forms the upstream side of the contact surface (apex portion) of the rib 640 to be in contact with the sheet P, and the downstream contact portion 644 forms the downstream side of the contact surface (apex portion) of the rib 640. The ribs 650 of the lower guide member 65 each include an inclined portion 653 (second inclined portion) inclined so that the distance to the upper guide member 64 decreases downstream in the conveyance direction, and a downstream contact portion 654 extending from the inclined portion 653 downstream in the conveyance direction. The downstream contact portions 644 and 654 are surfaces extending in parallel in the conveyance direction. As illustrated in FIG. 9, the conveyance path T is shaped in such a way that the clearance (the space through which the sheet P passes) in the sheet thickness direction increases upstream in the conveyance direction and decreases downstream in the conveyance direction because of the shapes of the inclined portions 643 and 653. The inclined portions 643 and 653 may be extended in a curved form when viewed from the widthwise direction.

The rib 640 includes the inclined portion 643, a side surface inclined portion 645 continuously formed from the downstream contact portion 644, and a side surface 646 continuously formed from the side surface inclined portion 645. The side surface inclined portion 645 is continuously formed from the edges of the inclined portion 643 and the downstream contact portion 644 farther from the conveyance center C, and is inclined to get farther away from the lower guide member 65 as the distance from the conveyance center C increases. The side surface 646 extends in the conveyance direction and the vertical direction (sheet thickness direction). The side surface inclined portion 645 connects the downstream contact portion 644 and the side surface 646.

When the sheet P is conveyed from the static elimination roller pair 50 to the non-contact type static elimination section 60, one corner of the leading edge of the sheet P may get into an opening 641 or 651. In such a case, the above-described side surface inclined portion 645 raises the edge of the sheet P and guides the edge to the inclined portion 643 and the downstream contact portion 644.

As described above, the ribs 640 of the upper guide member 64 each include the inclined portion 643 inclined to get closer to the lower guide member 65 downstream in the conveyance direction. Thus, the inclined portion 643 in the conveyance path T has a slope shape in which the sheet passage space gets larger upstream in the conveyance direction. This enables reduction of the possibility that the leading edge of the sheet P abuts onto the upper guide member 64 to cause a jam, for example, even if the sheet P having a curled leading edge is conveyed. Further, since the sheet passage space gets narrower downstream in the conveyance direction, the sheet behavior in the static elimination region 60a becomes stable, making it possible to reduce occurrences of a conveyance failure when the sheet P is subjected to the static elimination by the non-contact type static elimination section 60.

Like the ribs 640 of the upper guide member 64, the ribs 650 of the lower guide member 65 each include the inclined portion 653 inclined to get closer to the upper guide member 64 toward downstream in the conveyance direction. This enables further reduction of the possibility that a jam occurs when the sheet P is conveyed to the guide unit 63.

The ribs 640 of the upper guide member 64 are each obliquely extended in the conveyance direction to get farther away from the conveyance center C downstream in the conveyance direction. Further, the ribs 640 of the upper guide member 64 each include the side surface inclined portion 645 inclined to get farther away from the lower guide member 65 as the distance from the conveyance center C increases. This allows the edge of the conveyed sheet P to initially abut on the side surface inclined portion 645 and then be sent to the inclined portion 643 and the downstream contact portion 644, reducing the possibility that the edge of the sheet P abuts on the side surface 646 to cause a jam.

While, in the present exemplary embodiment, the lower guide member 65 has the same shape as the upper guide member 64 to reduce the possibility that a jam occurs, the lower guide member 65 may have a different shape from the upper guide member 64. For example, the ribs 650 of the lower guide member 65 may each guide the sheet P only with the downstream contact portion 654 without having the inclined portion 653.

While, in the present exemplary embodiment, the contact portion of each guide member for guiding the sheet P with the contact portion being in contact with the sheet P is formed of the plurality of ribs 640 and 650, the configuration of the contact portion is not so limited. For example, the contact portion of each guide member may be formed of a surface where a plurality of openings is arranged in the widthwise direction. In this case, it is suitable that the plurality of openings in the guide surfaces of the guide members 64 and 65 is disposed at positions corresponding to the static elimination needles 61a and 62a, respectively.

While, in the present exemplary embodiment, the ribs 640 and 650 are linearly extended when viewed from above, the shapes of the ribs 640 and 650 are not so limited. For example, the ribs 640 and 650 may be disposed in a curved form when viewed from above.

While, in the present exemplary embodiment, the non-contact type static elimination section 60 of the static elimination apparatus 300 includes the non-contact type static elimination units 61 and 62 disposed above and below the conveyance path T, the configuration of the static elimination apparatus 300 is not so limited. For example, the static elimination apparatus 300 may include only the non-contact type static elimination unit 61 disposed above the conveyance path T. More specifically, the upper guide member 64 may have the openings 641 but the lower guide member 65 may not have the openings 651. Likewise, in a configuration with only the non-contact type static elimination unit 62 disposed below the conveyance path T, the lower guide member 65 may have the openings 651 but the upper guide member 64 may not have the openings 641. The static elimination apparatus 300 according to the present exemplary embodiment includes both the non-contact type static elimination section 60 and the static elimination roller pair 50. However, the static elimination apparatus 300 may include only the non-contact type static elimination section 60.

The present disclosure makes it possible to provide a static elimination apparatus capable of reducing occurrences of a conveyance failure when a sheet passes through a non-contact type static elimination unit, and an image forming apparatus including the static elimination apparatus.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-011452, filed Jan. 30, 2023, which is hereby incorporated by reference herein in its entirety.

What is claimed is:

1. A static elimination apparatus comprising:
a conveyance unit configured to convey a sheet along a conveyance path;
a non-contact type static elimination unit configured to perform static elimination on the sheet being conveyed by the conveyance unit without being in contact with the sheet;
a first guide member including a contact portion configured to guide the sheet with the contact portion being in contact with the sheet being conveyed by the conveyance unit, having a plurality of openings arranged in a sheet widthwise direction perpendicular to a sheet conveyance direction and configured to expose the non-contact type static elimination unit to the conveyance path, and configured to form a part of the conveyance path; and
a second guide member disposed to face the first guide member and configured to form a part of the conveyance path together with the first guide member,
wherein the contact portion includes an inclined portion upstream in the sheet conveyance direction, wherein the inclined portion is inclined so that a distance to the second guide member decreases downstream in the sheet conveyance direction.

2. The static elimination apparatus according to claim 1, wherein the contact portion includes a plurality of ribs obliquely extended in the sheet conveyance direction to get away from a conveyance center downstream in the sheet conveyance direction.

3. The static elimination apparatus according to claim 2, wherein each of the plurality of ribs include a downstream contact portion continuously formed from the inclined portion and extended downstream in the sheet conveyance direction, and a side inclined portion continuously formed from the inclined portion and the downstream contact portion and inclined to get farther away from the second guide member as a distance from the conveyance center increases.

4. The static elimination apparatus according to claim 1,
wherein the contact portion includes a first rib, a second rib adjacent to the first rib, a third rib disposed more outwardly than the first and the second ribs in the sheet widthwise direction, and a fourth rib adjacent to the third rib,
wherein the plurality of openings includes a first opening formed between the first and the second ribs, and a second opening formed between the third and the fourth ribs, and
wherein a width of the first opening is larger than a width of the second opening in the sheet widthwise direction.

5. The static elimination apparatus according to claim 1, further comprising a static elimination roller pair configured to perform the static elimination on the sheet with the static elimination roller pair being in contact with the sheet, upstream of the non-contact type static elimination unit.

6. The static elimination apparatus according to claim 1,
wherein the contact portion includes the inclined portion, and a downstream contact portion downstream of the inclined portion in the sheet conveyance direction, and
wherein the plurality of openings is disposed in the downstream contact portion.

7. A static elimination apparatus comprising:
a conveyance unit configured to convey a sheet along a conveyance path;
a first non-contact type static elimination unit disposed above the conveyance path and configured to perform static elimination on the sheet being conveyed by the conveyance unit, without being in contact with the sheet;
a second non-contact type static elimination unit disposed below the conveyance path and configured to perform the static elimination on the sheet being conveyed by the conveyance unit, without being in contact with the sheet;
a first guide member including an upper surface contact portion configured to guide the sheet being conveyed by the conveyance unit with the upper surface contact portion being in contact with an upper surface of the sheet, having a plurality of openings arranged in a sheet widthwise direction perpendicular to a sheet conveyance direction and configured to expose the first non-contact type static elimination unit to the conveyance path, and configured to form a part of the conveyance path; and
a second guide member including a lower surface contact portion configured to guide the sheet being conveyed by the conveyance unit with the lower surface contact portion being in contact with a lower surface of the sheet, having a plurality of openings arranged in the sheet widthwise direction perpendicular to the sheet conveyance direction and configured to expose the second non-contact type static elimination unit to the conveyance path, and disposed to face the first guide member and configured to form a part of the conveyance path together with the first guide member,
wherein the upper surface contact portion includes a first inclined portion upstream in the sheet conveyance direction, wherein the first inclined portion is inclined so that a distance to the second guide member decreases downstream in the sheet conveyance direction, and
wherein the lower surface contact portion includes a second inclined portion upstream in the sheet conveyance direction, wherein the second inclined portion is inclined so that a distance to the first guide member decreases downstream in the sheet conveyance direction.

8. An image forming apparatus comprising:
the static elimination apparatus according to claim 1; and
an image forming unit including a transfer unit configured to transfer a toner image onto a sheet, and a fixing unit configured to heat and pressurize the sheet with the toner image transferred thereon, to fix the toner image to the sheet,
wherein the static elimination apparatus is disposed downstream of the image forming unit and configured to perform the static elimination on the sheet with the image formed thereon by the image forming unit.
